(19) United States
(12) Patent Application Publication
(10) Pub. No.: US 2013/0050305 A1
(43) Pub. Date: Feb. 28, 2013

(54) DRIVE CIRCUIT, DISPLAY, AND METHOD OF DRIVING DISPLAY

(71) Applicant: Tomoro Yoshinaga, Kanagawa (JP)

(72) Inventor: Tomoro Yoshinaga, Kanagawa (JP)

(73) Assignee: Sony Corporation, Tokyo (JP)

(21) Appl. No.: 13/567,671

(22) Filed: Aug. 6, 2012

(30) Foreign Application Priority Data
Aug. 31, 2011 (JP) 2011-189929

(51) Int. Cl. G09G 5/10

(52) U.S. Cl. 345/694

(57) ABSTRACT

A drive circuit includes: a division section and an ON-OFF-period control section. The division section divides one frame period into a plurality of subfields, and divides each of one or more of the plurality of subfields to generate a plurality of division subfields. Each of the subfields corresponds to each bit of gray-scale data and has a period corresponding to a weight of the corresponding bit, and each of the one or more of the subfields has the period that is relatively long and is divided into periods each equal to the period of the subfield that is relatively short. The ON-OFF-period control section controls a ratio of an ON period or an OFF period to the one frame period, by turning on or off an electro-optical device of each pixel according to the bit corresponding to each of the subfields and each of the division subfields.

### BACKGROUND

The technology relates to a drive circuit that performs gray-scale display with pulse width modulation (PWM), and to a display having the drive circuit. The technology also relates to a method of driving the display.

When a case of five bits (32-level gray scale) is taken as an example, a gray-scale display method as illustrated in FIG. 18 according to a comparative example, for instance, is used in a digital-driving display that performs gray-scale display with PWM. Specifically, as illustrated in FIG. 18, five pieces of data in a 1:2:4:8:16 period ratio are prepared using data of one bit with a width of a few milliseconds as a unit, for instance. The 32-level gray scale is expressed by a combination of these five pieces of data.

Part (A) to Part (D) of FIG. 19 illustrate a relationship between signal data in sequential scanning and selection pulses applied to scanning lines, in typical digital driving according to a comparative example. Here, a case of using three scanning lines is illustrated for the sake of description. As illustrated in Part (A) to Part (D) of FIG. 19, in a display of typical digital driving, one frame period (1F) is divided into subfields SF1 to SF5 corresponding to the respective bits (in this case, a first bit to a fifth bit) of gray-scale data. The subfields SF1 to SF5 are periods each depending on the weight of the corresponding bit. The ratio of an ON period or an OFF period to the 1F is controlled stepwise, by turning an electro-optical device of a pixel on or off in accordance with the bit corresponding to each of the subfields SF1 to SF5. Writing data to the pixel through the scanning line is performed in line-sequential scanning, for each of the subfields SF1 to SF5. It is to be noted that information about the digital driving is described in, for example, Japanese Unexamined Patent Application Publication No. 2006-343609.

### SUMMARY

Part (A) to Part (C) of FIG. 20 schematically illustrate a moving image in a state of being displayed in digital driving of FIG. 18 according to a comparative example. In this moving image, an image having gradation in a vertical direction (which will be hereinafter referred to as “gradation image”) changes vertically upwards. Part (A) of FIG. 20 illustrates a part of the gradation image visually recognized by a viewer. Part (B) of FIG. 20 illustrates digital display of how the gradation image temporally changes vertically upwards, from nth frame to (n+2)th frame. Part (C) of FIG. 20 illustrates a part of the moving image visually recognized by the viewer, when the gradation image temporally changes vertically upwards.

Part (A) to Part (C) of FIG. 20 indicate that when a gray-scale display method in which a black or white phase is inverted due to a slight difference in gray-scale is used, the gradation image temporally changes vertically upwards, which causes a black streak L1 in a pixel where the black or white phase is inverted. The gradation image tends to appear near the outline of the face of a person. Hence, the generation of the black streak L1 described above occurs easily near the outline of the face of the person in an image where there is a movement in the face of the person. The black streak L1 appearing near the outline of the face of the person is formed along the outline of the face of the person, and thus is called a “pseudo outline”. The pseudo outline significantly impairs image quality and therefore, development of a driving method resistant to occurrence of the pseudo outline has been expected.

It is desirable to provide a drive circuit resistant to occurrence of a pseudo outline, and a display having this drive circuit. It is also desirable to provide a method of driving a display resistant to occurrence of a pseudo outline.

According to an embodiment of the technology, there is provided a drive circuit driving each of pixels that are arranged in matrix in a display, in which each of the pixels is provided with a built-in memory that includes an electro-optical device. The drive circuit includes: a division section dividing one frame period into a plurality of subfields, and dividing each of one or more of the plurality of subfields to generate a plurality of division subfields, each of the plurality of subfields corresponding to each bit of gray-scale data and having a period corresponding to a weight of the corresponding bit, and each of the one or more of the plurality of subfields having the period that is relatively long and being divided into periods each equal to the period of the subfield that is relatively short; and an ON-OFF-period control section controlling a ratio of an ON period or an OFF period to the one frame period, by turning on or off the electro-optical device of each of the pixels according to the bit corresponding to each of the subfields and each of the division subfields.

According to an embodiment of the technology, there is provided a display with a display region and a drive circuit, in which the display region is provided with pixels that are arranged in matrix and each having a built-in memory that includes an electro-optical device, and the drive circuit drives each of the pixels. The drive circuit includes: a division section dividing one frame period into a plurality of subfields, and dividing each of one or more of the plurality of subfields to generate a plurality of division subfields, each of the plurality of subfields corresponding to each bit of gray-scale data and having a period corresponding to a weight of the corresponding bit, and each of the one or more of the plurality of subfields having the period that is relatively long and being divided into periods each equal to the period of the subfield that is relatively short; and an ON-OFF-period control section controlling a ratio of an ON period or an OFF period to the one frame period, by turning on or off the electro-optical device of each of the pixels according to the bit corresponding to each of the subfields and each of the division subfields.

According to an embodiment of the technology, there is provided a method of driving a display, in which the display is provided with pixels that are arranged in matrix and each having a built-in memory that includes an electro-optical device. The method includes: dividing one frame period into a plurality of subfields, and dividing each of one or more of the plurality of subfields to generate a plurality of division subfields, each of the plurality of subfields corresponding to each bit of gray-scale data and having a period corresponding to a weight of the corresponding bit, and each of the one or more of the plurality of subfields having the period that is relatively long and being divided into periods each equal to the period of the subfield that is relatively short; and controlling a ratio of an ON period or an OFF period to the one frame period, by turning on or off the electro-optical device of each of the pixels according to the bit corresponding to each of the subfields and each of the division subfields.

In the drive circuit, the display, and the method of driving the display according to the above-described embodiments of the technology, each of the one or more of the plurality of subfields each having the period that is relatively long is divided into the periods each equal to the period of the subfield having the period that is relatively short. This allows a reduction in a degree to which a border between black and white stays for a long time due to a slight difference in gray-scale.

According to the drive circuit, the display, and the method of driving the display in the above-described embodiments of the technology, the degree, to which a border between black and white stays for a long time due to a slight difference in gray-scale, is reduced. This suppresses generation of a streak. Thus, a pseudo outline is allowed to be less likely to appear. As a result, achievement of high image quality is allowed.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a schematic diagram of a display according to an embodiment of the technology.

Part (A) and Part (B) of FIG. 2 are schematic diagrams illustrating an example of signal data defined by subfields.

FIG. 3 is a schematic diagram illustrating an example of gray-scale data.

Part (A) to Part (C) of FIG. 4 are schematic diagrams illustrating an example of a relationship in terms of gray-scale data, between frames.

Part (A) to Part (C) of FIG. 5 are schematic diagrams illustrating another example of the relationship in terms of gray-scale data, between frames.

FIG. 6 is a schematic diagram of a conversion circuit in FIG. 1.

Part (A) to Part (D) of FIG. 7 are schematic diagrams illustrating an example of signal data and examples of a selection pulse, in one frame period.

Part (A) to Part (C) of FIG. 8 are schematic diagrams illustrating an example of a temporal change in a gradation image.

Part (A) to Part (C) of FIG. 9 are schematic diagrams illustrating another example of the temporal change in the gradation image.

Part (A) and Part (B) of FIG. 10 are schematic diagrams illustrating another example of the signal data defined by the subfields.

FIG. 11 is a schematic diagram illustrating another example of the gray-scale data.

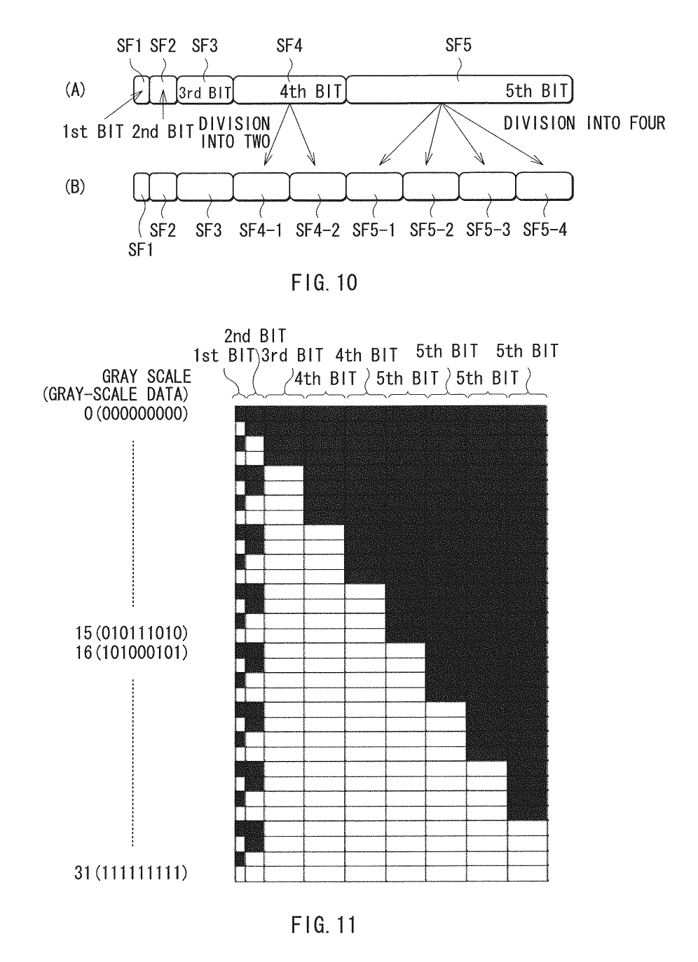

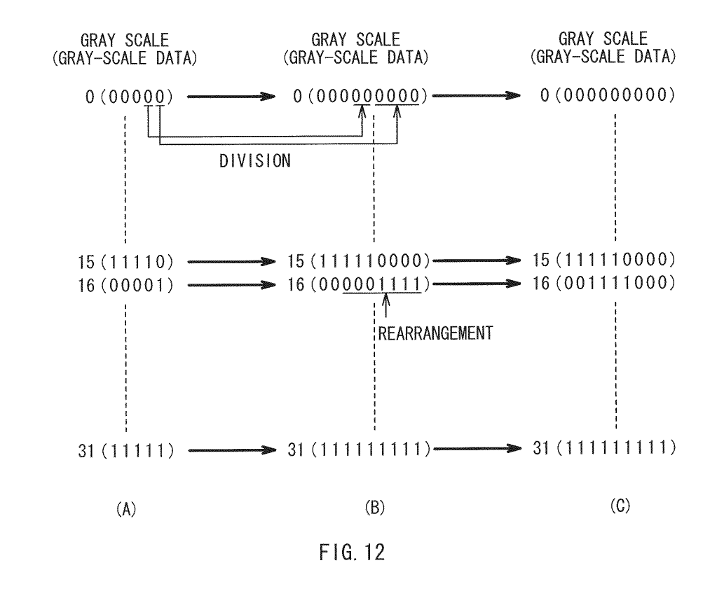

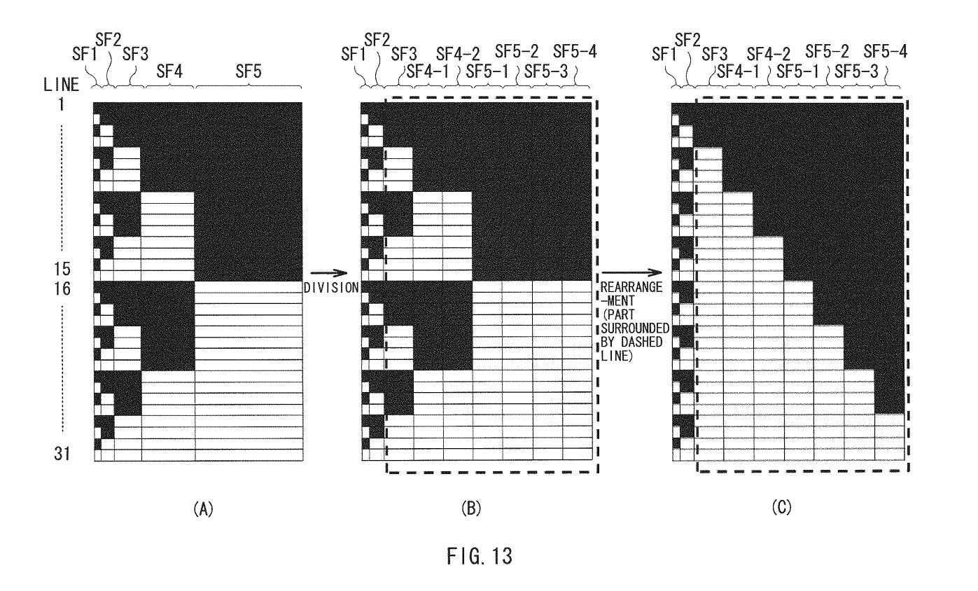

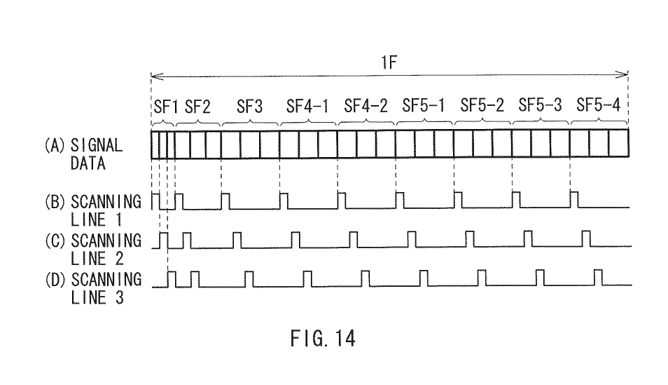

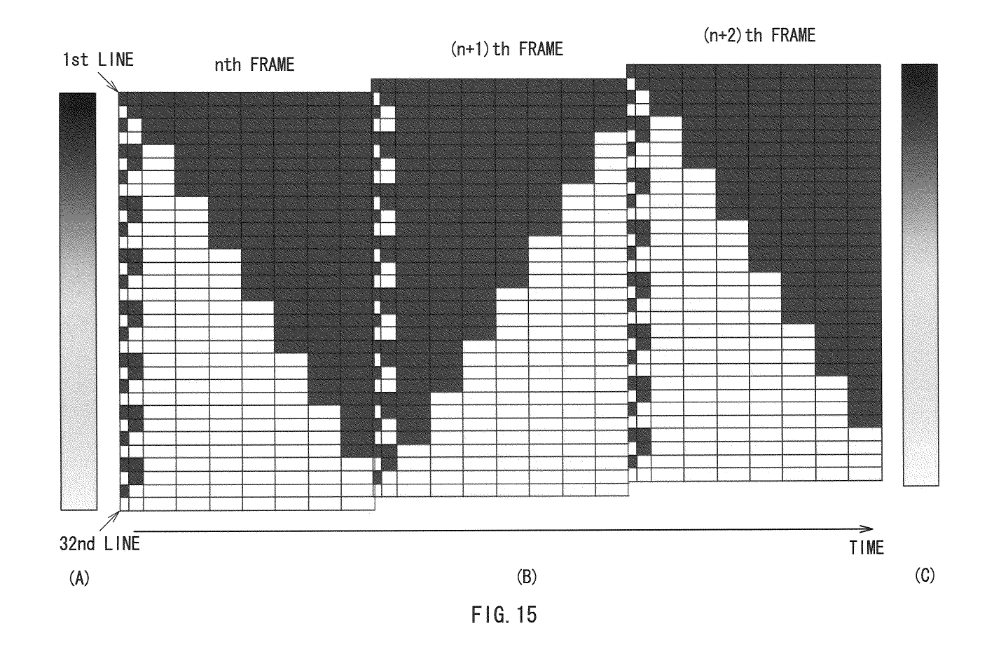

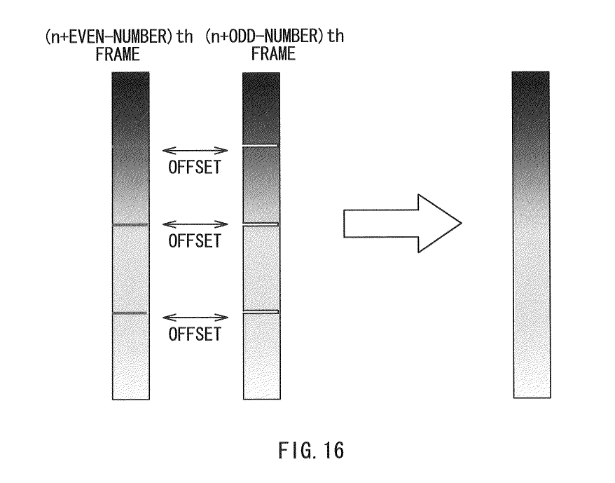

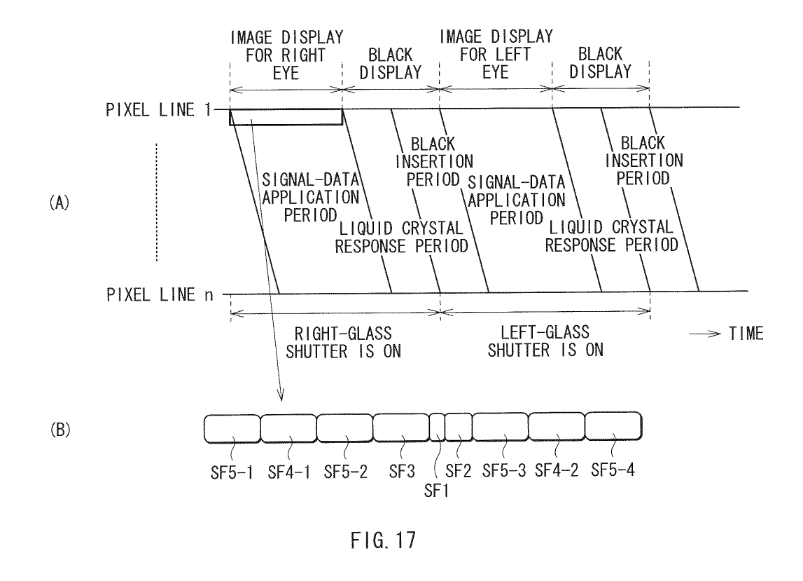

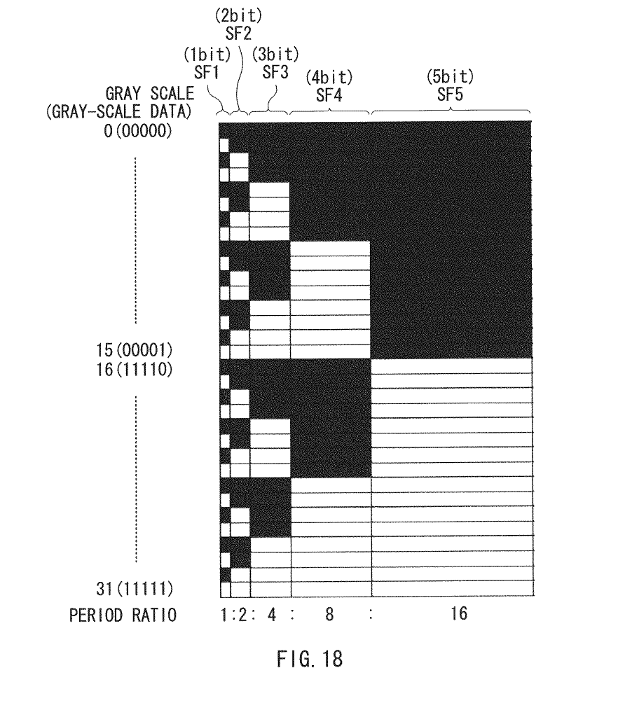

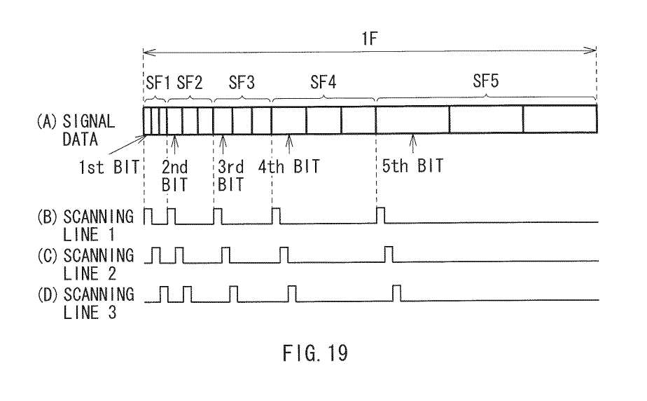

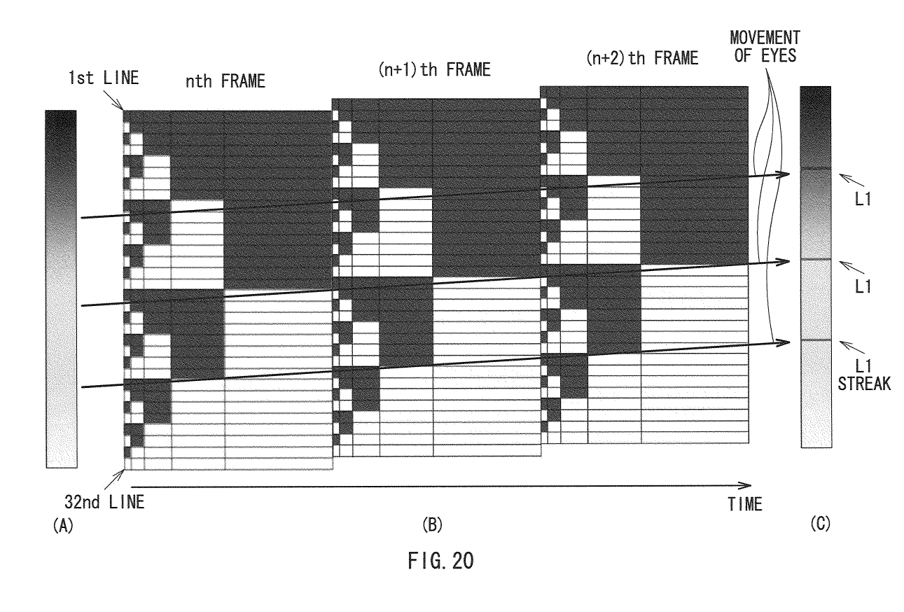

Part (A) to Part (C) of FIG. 12 are diagrams illustrating an example of a method of generating the gray-scale data in FIG. 11, in form of bits.

Part (A) to Part (C) of FIG. 13 are diagrams illustrating the bits in Part (A) to Part (C) of FIG. 12, respectively, in form of black and white.

Part (A) to Part (D) of FIG. 14 are schematic diagrams illustrating another example of the signal data and other examples of the selection pulse, in the one frame period.

Part (A) to Part (C) of FIG. 15 are schematic diagrams illustrating still another example of the temporal change in the gradation image.

FIG. 16 is a diagram used to describe a relationship between (n+even-number)th frame and (n+odd-number)th frame.

Part (A) and Part (B) of FIG. 17 are diagrams illustrating an example of a drive sequence and an example of signal data, respectively, when a gray-scale display method of the embodiment is applied to a 3D display using polarized shutter glasses.

FIG. 18 is a schematic diagram illustrating an example of gray-scale data according to a comparative example.

Part (A) to Part (D) of FIG. 19 are schematic diagrams illustrating a typical example of signal data and typical examples of a selection pulse, in one frame period according to a comparative example.

Part (A) to Part (C) of FIG. 20 are schematic diagrams illustrating a typical example of a temporal change in a gradation image.

### DETAILED DESCRIPTION

An embodiment of the technology will be described below in detail with reference to the drawings. It is to be noted that the description will be provided in the following order.
1. Embodiment (a display)
2. Modifications (displays)
[1. Embodiment]
[Configuration]

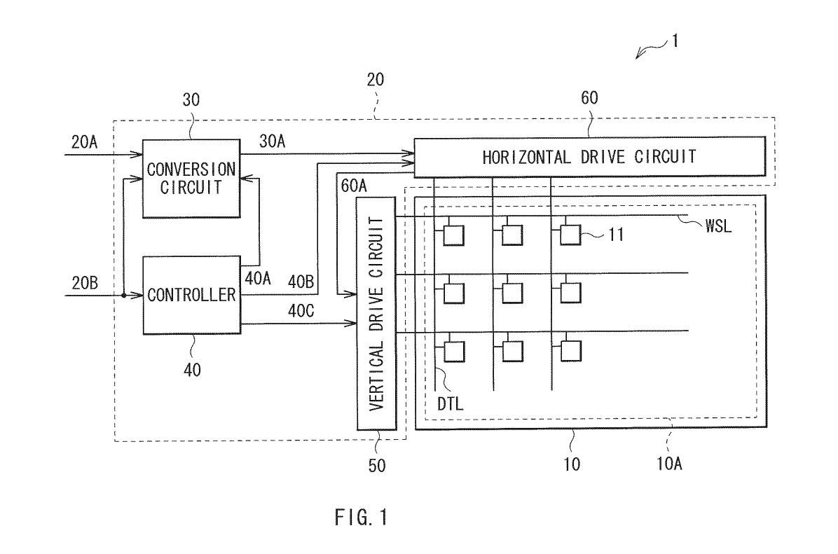

FIG. 1 illustrates a schematic configuration of a display 1 according to an embodiment of the technology. This display 1 includes a display panel 10 and a peripheral circuit 20 driving the display panel 10.

### (Display Panel 10)

The display panel 10 includes a plurality of scanning lines WSL extending in a row direction, and a plurality of data lines DTL extending in a column direction. The display panel 10 further includes a plurality of pixels 11 each corresponding to an intersection of each of the scanning lines WSL and each of the data lines DTL. The plurality of pixels 11 in the display panel 10 are two-dimensionally arranged in the row direction and the column direction, all over a pixel region 10A of the display panel 10. The pixel 11 corresponds to a point that is a minimum unit of a screen on the display panel 10. When the display panel 10 is a color display panel, the pixel 11 is equivalent to, for example, a subpixel that emits light of single color such as red, green, or blue. When the display panel 10 is a monochrome display panel, the pixel 11 is equivalent to a pixel that emits monochromatic light (e.g., white light).

The pixel 11 is a pixel with a built-in memory including an electro-optical device, although not illustrated. Examples of the type of the electro-optical device include a liquid crystal cell and organic EL (Electroluminescence). Examples of the type of the memory include SRAM (Static Random Access Memory) and DRAM (Dynamic Random Access Memory). When corresponding one of the scanning lines WSL is selected, the pixel 11 enters an emission state or an extinction state in response to writing of signal data (bit) supplied to the corresponding data line DTL. Even when this scanning line WSL is not selected anymore afterwards, the emission state or the extinction state based on the writing continues. Therefore, the peripheral circuit 20 achieves gray-scale display, by controlling the ratio of a period during which the pixel 11 is in the emission state (i.e. a lighted period) or a period during which the pixel 11 is in the extinction state (i.e. an extinguished period), to one frame period.

There is a concept called “subfield” serving as a unit of the lighted period or the extinguished period of the pixel 11. The “subfield” corresponds to each bit of gray-scale data defining gray-scale of the pixel 11, and indicates a unit of a period depending on the weight of the corresponding bit. For example, when 32-level gray scale is expressed by 5-bit gray-scale data, as illustrated in FIG. 18 according to a comparative example, for instance, five pieces of data in a 1:2:4:8:16 period ratio are prepared using, for example, data of one bit having a width of a few milliseconds, as a unit. The 32-level gray scale is expressed by a combination of these five pieces of data. In this gray-scale display method, as illustrated in Part (A) of FIG. 2, signal data is defined by subfields SF1 to SF5 corresponding to the respective bits (a first bit to a fifth bit) of the gray-scale data. Each of the subfields SF1 to SF5 serves as a period depending on the weight of the corresponding bit.

In the present embodiment, further, “division subfield” is applied to a subfield with a relatively-long period (i.e. on a high gray-scale side), as a unit of the lighted period or the extinguished period of the pixel 11. The “division subfield” indicates a fragment subfield, which is generated by dividing a subfield with a relatively-long period into periods each equal to the period of a subfield with a relatively-short period. For example, as illustrated in Part (B) of FIG. 2, the subfields SF4 and SF5 corresponding to the fourth bit and the fifth bit of the gray-scale data, respectively, are divided into periods each equal to the period of the subfield SF3. The period of the subfield SF3 is relatively shorter than the subfield SF4. As a result, two division subfields SF4-1 and SF4-2 are generated from the subfield SF4, and four division subfields SF5-1, SF5-2, SF5-3, and SF5-4 are generated from the subfield SF5. The period of each of the division subfields SF4-1, SF4-2, SF5-1, SF5-2, SF5-3, and SF5-4 is longer than the period of each of the subfields SF1 and SF2 on a low gray-scale side, and is the longest period in the signal data.

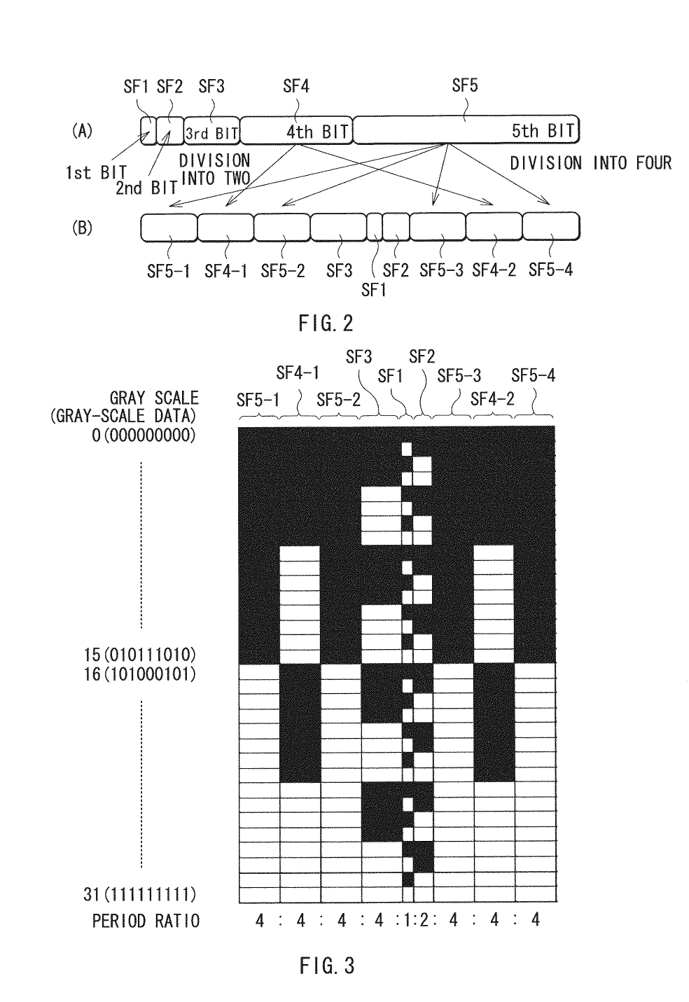

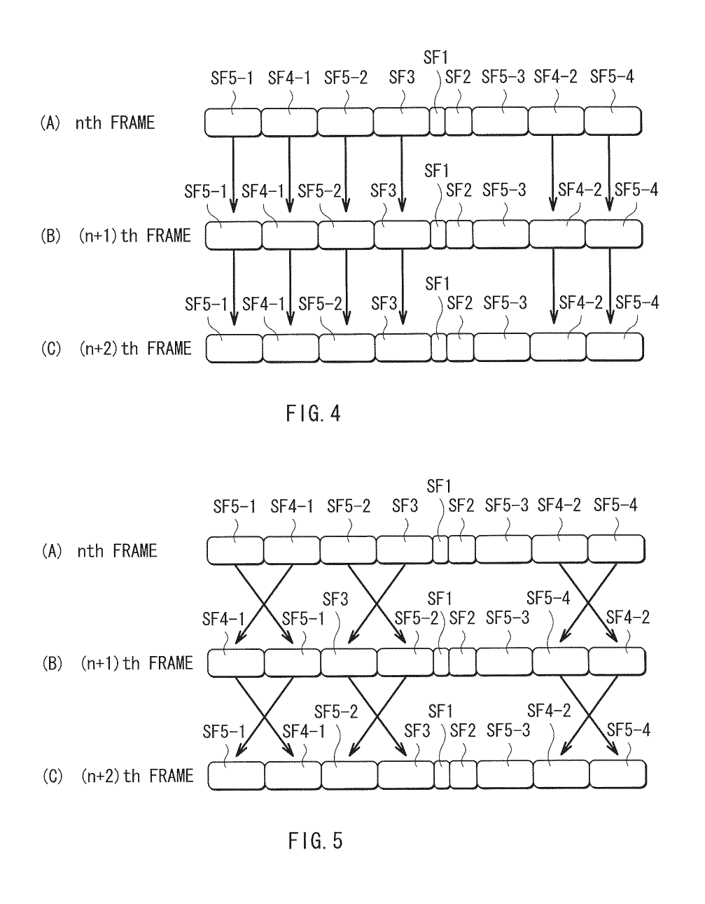

Here, the bit corresponding to the division subfield is equal to the bit corresponding to the subfield that is a source of the division resulting in the division subfield. For example, the bit corresponding to each of the division subfields SF4-1 and SF4-2 is equal to the bit corresponding to the subfield SF4. Similarly, the bit corresponding to each of the division subfields SF5-1, SF5-2, SF5-3, and SF5-4 is equal to the bit corresponding to the subfield SF5. In the present embodiment, when gray-scale data with 32-level gray scale expressed by five bits (see FIG. 18) is inputted, for example, nine pieces of data in a 4:4:4:4:1:2:4:4:4 period ratio are prepared using, for example, data of one bit having a width of a few milliseconds, as a unit, as illustrated in FIG. 3, for instance. The 32-level gray scale is expressed by a combination of these nine pieces of data. In this case, the second period and the eighth period from the lead correspond to the division subfields SF4-1 and SF4-2, respectively. In addition, the first period, the third period, the seventh period, and the ninth period from the lead correspond to the division subfields SF5-1, SF5-2, SF5-3, and SF5-4, respectively. In this gray-scale display method, a degree, to which a border between black and white stays for a long time due to a slight difference in gray-scale between two pixels next to each other, is lower than that in the gray-scale display method illustrated in FIG. 18.

In the gray-scale display method described above, at least a part of (each of one or more of) the division subfields are each placed in a section different from that before the division, in the one frame period. Further, the division subfields are placed so that the subfields as a source of the division, each divided into the division subfields next to each other, are different from each other. For example, as illustrated in Part (B) of FIG. 2, the division subfield SF4-1 generated from the subfield SF4 is placed next to the division subfields SF5-1 and SF5-2 generated from the subfield SF5. Further, the division subfield SF4-2 generated from the subfield SF4 is placed next to the division subfields SF5-3 and SF5-4 generated from the subfield SF5. Similarly, the division subfield SF5-1 generated from the subfield SF5 is placed at the lead of the signal data, and also placed next to the division subfield SF4-1 generated from the subfield SF4. Further, the division subfield SF5-2 generated from the subfield SF5 is placed next to the division subfield SF4-1 generated from the subfield SF4 and also to the subfield SF3 which is not divided. Furthermore, the division subfield SF5-3 generated from the subfield SF5 is placed next to the division subfield SF4-2 generated from the subfield SF4 and also to the subfield SF2 which is not divided. The division subfield SF5-4 generated from the subfield SF5 is placed at the tail of the signal data, and also placed next to the division subfield SF4-2 generated from the subfield SF4.

It is preferable that a part of (some of) the division subfields be placed closer to the beginning of the one frame period. For example, as illustrated in Part (B) of FIG. 2, the division subfield SF5-1 generated from the subfield SF5 is placed at the lead of the one frame period (the signal data). Further, for example, the division subfield SF4-1 generated from the subfield SF4 is placed at the second position from the lead of the one frame period (the signal data) as illustrated in Part (B) of FIG. 2.

Further, for example, the position of the division subfield may be fixed regardless of the frame period. For instance, in any of nth frame, (n+)th frame, and (n+2)th frame, the signal data may be defined in an order of SF5-1, SF4-1, SF5-2, SF3, SF1, SF2, SF5-3, SF4-2, and SF5-4, sequentially from the lead as illustrated in Part (A) to Part (C) of FIG. 4.

Furthermore, for example, the positions of at least a part of (some of) the division subfields generated from each of the subfields different from each other as a source of the division, may be replaced with each other, for every frame period. Still further, the positions of the division subfields as well as the subfields may be replaced with each other for every frame period. For example, as illustrated in Part (A) to Part (C) of FIG. 5, suppose signal data is defined in an order of SF5-1, SF4-1, SF5-2, SF3, SF1, SF2, SF5-3, SF4-2, and SF5-4 sequentially from the lead, in the nth frame. At this moment, in the (n+1)th frame, SF5-1 in the first position and SF4-1 in the second position are replaced with each other, the SF5-2 in the third position and SF3 in the fourth position are replaced with each other, and the SF4-2 in the eighth position and SF5-4 in the ninth position are replaced with each other. Further, in the (n+2)th frame, SF4-1 in the first position and SF5-1 in the second position are replaced with each other, SF3 in the third position and SF5-2 in the fourth position are replaced with each other, and SF5-4 in the eighth position and SF4-2 in the ninth position are replaced with each other.

### (Peripheral Circuit 20)

Next, a configuration of the peripheral circuit 20 will be described. The peripheral circuit 20 includes, for example, a conversion circuit 30, a controller 40, a vertical drive circuit 50, and a horizontal drive circuit 60, as illustrated in FIG. 1.

The controller 40 generates control signals 40A, 40B, and 40C that control operation timing of the conversion circuit 30, the vertical drive circuit 50, and the horizontal drive circuit 60, based on a synchronization signal 20B supplied from a host unit not illustrated. Examples of the synchronization signal 20B include a vertical synchronizing signal, a horizontal synchronizing signal, and a dot clock signal. Examples of the control signals 40A, 40B, and 40C include a clock signal, a latch signal, a start of frame signal, and a subfield start signal.

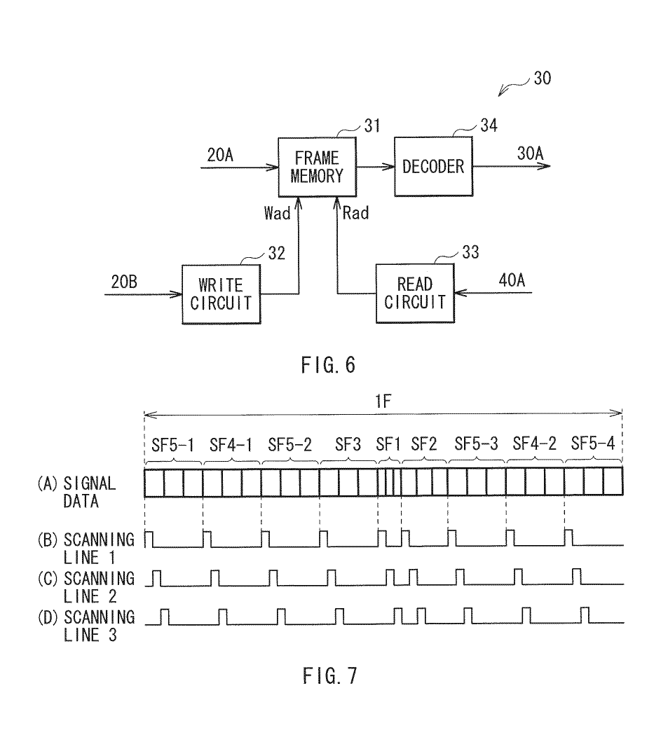

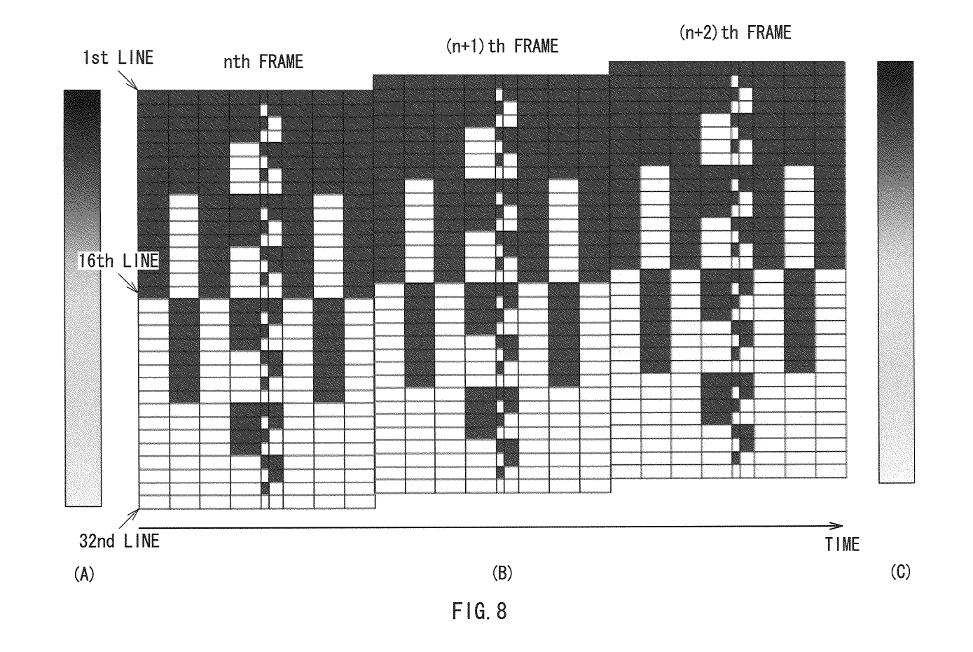

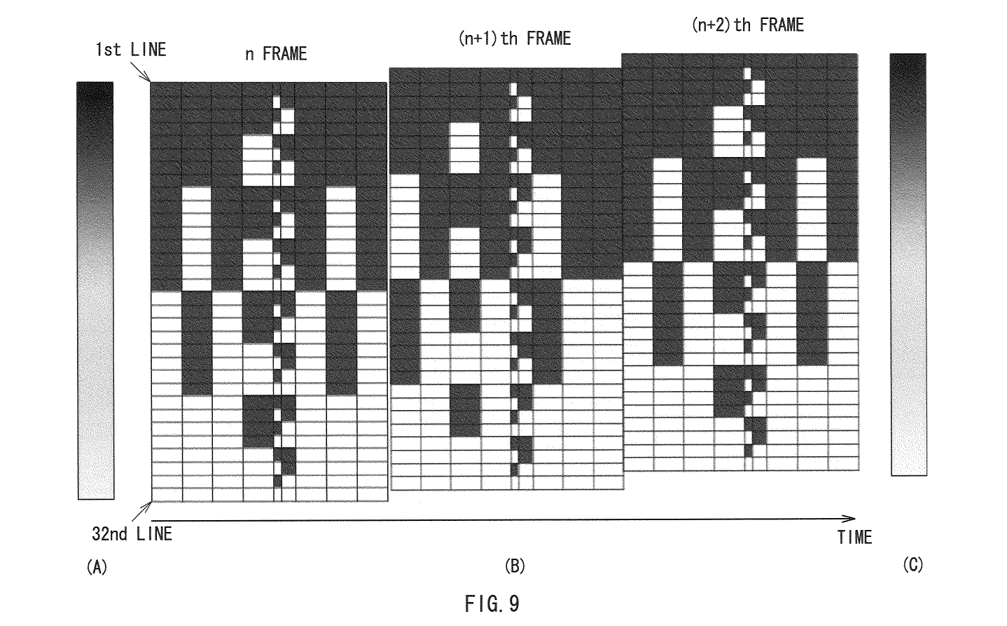

The conversion circuit 30 includes, for example, a frame memory 31, a write circuit 32, a read circuit 33, and a decoder 34, as illustrated in FIG. 6. The frame memory 31 is a memory for image display, and has a memory capacity at least larger than the resolution of the pixel region 10A. The frame memory 31 is capable of storing, for example, a row address, a column address, and gray-scale data of each of the pixels 11 associated with the row address and the column address. The write circuit 32 generates a write address Wad of an image signal 20A by using the synchronization signal 20B, and outputs the generated write address Wad to the frame memory 31 synchronously with the synchronization signal 20B. The write address Wad includes, for example, the row address and the column address. The read circuit 33 generates a reading address Rad based on the control signal 40A, and outputs the generated reading address Rad to the frame memory 31. The decoder 34 outputs the gray-scale data outputted from the frame memory 31, as signal data 30A.

The vertical drive circuit 50 outputs a scanning pulse used to select each of the pixels 11 row by row. The scanning pulse is outputted to the scanning line WSL, based on a control signal 60A (which will be described later) inputted from the horizontal drive circuit 60, and address data identified by the control signal 40C. For instance, the vertical drive circuit 50 sequentially outputs a selection pulse to each of the scanning lines WSL, corresponding to sequential positions and periods of SF5-1, SF4-1, SF5-2, SF3, SF1, SF2, SF5-3, SF4-2, and SF5-4, as illustrated in Part (A) to Part (D) of FIG. 7.

The horizontal drive circuit 60 controls the ratio of the ON period or the OFF period to 1F stepwise, by turning on or off the electro-optical device of the pixel 11 based on the control signal 40B and the signal data 30A.

The horizontal drive circuit 60 divides the subfield on the high-bit side of the signal data 30A into the division subfields each having the same period as that of the subfield on the low-bit side of the signal data 30A. When the gray-scale data with 32-level gray scale expressed by five bits (see FIG. 18) is inputted as the signal data 30A, the horizontal drive circuit 60 divides each of the subfields SF4 and SF5 corresponding to the fourth bit and the fifth bit of the gray-scale data, respectively. Here, each of the subfields SF4 and SF5 is divided into periods that are each equal to the period of the subfield SF3, as illustrated in Part (B) of FIG. 2, for example. The period of the subfield SF3 is relatively shorter than that of the subfield SF4. As a result, the two division subfields SF4-1 and SF4-2 are generated from the subfield SF4, and the four division subfields SF5-1, SF5-2, SF5-3, and SF5-4 are generated from the subfield SF5.

Next, the horizontal drive circuit 60 places at least a part of (each of one or more of) the division subfields in a section different from that before the division, in the one frame period. Further, the horizontal drive circuit 60 places each of the division subfields, so that the subfields as a source of the division, each divided into the division subfields next to each other, are different from each other. Specifically, for example, the horizontal drive circuit 60 places the subfields SF1, SF2, and SF3 as well as the division subfields SF4-1, SF4-2, SF5-1, SF5-2, SF5-3, and SF5-4, in an order of SF5-1, SF4-1, SF5-2, SF3, SF1, SF2, SF5-3, SF4-2, and SF5-4 as illustrated in Part (B) of FIG. 2.

At this moment, it is preferable that the horizontal drive circuit 60 place a part of (some of) the division subfields at a position closer to the beginning of the one frame period. For example, as illustrated in Part (B) of FIG. 2, the horizontal drive circuit 60 places the division subfield SF5-1 at the lead of the one frame period (the signal data). Further, for instance, the horizontal drive circuit 60 places the division subfield SF4-1 in the position second from the lead of the one frame period (the signal data), as illustrated in Part (B) of FIG. 2.

In addition, it is preferable that, when placing at least a part of (each of one or more of) the division subfields in a section different from that before the division in the one frame period, and further, placing each of the division subfields so that the subfields as a source of the division, each being divided into the division subfields next to each other, are different from each other, the horizontal drive circuit 60 arrange bit arrays in time symmetry in the one frame period. Moreover, it is preferable that, when placing at least a part of (each of one or more of) the division subfields in a section different from that before the division in one frame period, and further, placing each of the division subfields so that the subfields as a source of the division, each being divided into the division subfields next to each other, are different from each other, the horizontal drive circuit 60 arrange bit arrays in time symmetry in a plurality of frame periods.

Here, the “arrangement in time symmetry” indicates that, with respect to a certain time, the black or white phases of the respective periods before this certain time and those of the respective periods after this certain time are symmetrical or substantially symmetrical. The case where “the bit arrays are arranged in time symmetry in the one frame period” may refer to the following. For example, with respect to the subfield SF1, the black or white phases of the respective periods (SF5-1, SF4-1, SF5-2, and SF3) before the subfield SF1 and those of the respective periods (SF2, SF5-3, SF4-2, and SF5-4) after the subfield SF1 are symmetrical or substantially symmetrical. For instance, as illustrated in 16th line in Part (B) of FIG. 5, based on the subfield SF1, the black or white phases of the respective periods (SF5-1, SF4-1, SF5-2, and SF3) before the subfield SF1 are “0101”. On the other hand, as illustrated in the 16th line in Part (B) of FIG. 5, based on the subfield SF1, the black or white phases of the respective periods (SF2, SF5-3, SF4-2, and SF5-4) are “1010”. Here, “1010” is equal to the opposite of “0101” reversed at the subfield SF1. Therefore, in the 16th line in Part (B) of FIG. 5, the black and white phases “0101” of the periods before the subfield SF1 and the black and white phases “1010” of the periods after the subfield SF1 are symmetrical with respect to the subfield SF1.

Further, the case where “the bit arrays are arranged in time symmetry in the plurality of frame periods” may refer to the following. For example, with respect to a border between the nth frame period and the (n+1)th frame period, the black and white phases of the gray-scale data in the nth frame period and the black and white phases of the gray-scale data in the (n+1)th frame period are symmetrical or substantially symmetrical. For instance, as illustrated in the 16th line in Part (B) of FIG. 5, the gray-scale data in the nth frame period is “101000101”. On the other hand, the gray-scale data in the (n+1)th frame period is “101000101”, as illustrated in the 16th line in Part (B) of FIG. 5. Here, “101000101” is equal to “101000101” when folded at the border between the nth frame period and the (n+1)th frame period. Therefore, the black and white phases “101000101” in the nth frame period and the black and white phases “101000101” in the (n+1)th frame period are symmetrical with respect to the border between the nth frame period and the (n+1)th frame period, in the 16th line in Part (B) of FIG. 5.

Meanwhile, when the bit arrays are arranged in time symmetry in the one frame period or the plurality of frame periods, a streak generated by the former bit array and a streak generated by the latter bit array are opposite in terms of black and white. In other words, one is a black streak, whereas the other is a white streak (see a diagram on the left side in FIG. 16). Here, changes in black-white inversion over time are recognized by human eyes as an integrated value. Therefore, when the bit arrays are arranged in time symmetry in the one frame period or the plurality of frame periods, the human eyes perceive no streak because the black streak and the white streak are offset by each other.

For example, as illustrated in Part (A) to Part (C) of FIG. 5, the positions of at least a part of (some of) the division subfields, respectively generated from the subfields different from each other as a source of the division, are replaced with each other by the horizontal drive circuit 60, for every frame period. Further, for example, as illustrated in Part (A) to Part (C) of FIG. 5, the positions of the division subfields as well as the subfields having the same periods may be replaced with each other by the horizontal drive circuit 60, for every frame period. For example, as illustrated in Part (A) to Part (C) of FIG. 5, the horizontal drive circuit 60 defines the signal data in the order of SF5-1, SF4-1, SF5-2, SF3, SF1, SF2, SF5-3, SF4-2, and SF5-4 sequentially from the lead. At this moment, in the (n+1)th frame, SF5-1 in the first position and SF4-1 in the second position are replaced with each other, the SF5-2 in the third position and SF3 in the fourth position are replaced with each other, and the SF4-2 in the eighth position and SF5-4 in the ninth position are replaced with each other, by the horizontal drive circuit 60. Further, in the (n+2)th frame, SF4-1 in the first position and SF5-1 in the second position are replaced with each other, SF3 in the third position and SF5-2 in the fourth position are replaced with each other, and SF5-4 in the eighth position and SF4-2 in the ninth position are replaced with each other, by the horizontal drive circuit 60.

It is to be noted that, for example, the horizontal drive circuit 60 may fix the positions of the division subfields regardless of the frame period. For example, in any of the nth frame, the (n+1)th frame, and the (n+2)th frame, the horizontal drive circuit 60 may define the signal data, in the order of SF5-1, SF4-1, SF5-2, SF3, SF1, SF2, SF5-3, SF4-2, and SF5-4, sequentially from the lead, as illustrated in Part (A) to Part (C) of FIG. 4.

In addition, the horizontal drive circuit 60 outputs, to the vertical drive circuit 50, the control signal 60A corresponding to the sequential positions and the periods of the subfields and the division subfields of the signal data 30A after correction.

### [Effects]

Now, effects of the display 1 of the present embodiment will be described, by making a comparison with digital driving according to a comparative example.

In PWM-digital driving, for instance, a gray-scale display method like the one illustrated in FIG. 18 according to a comparative example is used when a case of five bits (32-level gray scale) is taken as an example. Specifically, as illustrated in FIG. 18, for instance, five pieces of data in a 1:2:4:8:16 period ratio are prepared, using data of one bit having a width of a few milliseconds as a unit, for instance, and the 32-level gray scale is expressed by a combination of these five pieces of data.

Part (A) to Part (D) of FIG. 19 illustrate a relationship between signal data in sequential scanning and selection pulses applied to scanning lines, in the typical digital driving according to a comparative example. Here, a case of using the three scanning lines is illustrated for the sake of description. As illustrated in Part (A) to Part (D) of FIG. 19, in a display of the typical digital driving, one frame period (1F) is divided into subfields SF1 to SF5 corresponding to the respective bits (in this case, a first bit to a fifth bit) of gray-scale data. The subfields SF1 to SF5 are periods each depending on the weight of the corresponding bit. The ratio of an ON period or an OFF period to the 1F is controlled stepwise, by turning an electro-optical device of a pixel on or off in accordance with the bit corresponding to each of the subfields SF1 to SF5. Further, writing data to the pixel through the scanning line is performed in line-sequential scanning for each of the subfields SF1 to SF5.

Part (A) to Part (C) of FIG. 20 schematically illustrate a moving image in a state of being displayed in the digital driving in Part (A) to Part (C) of FIG. 19. In this moving image, a gradation image changes vertically upwards. Part (A) of FIG. 20 illustrates a part of the gradation image visually recognized by a viewer. Part (B) of FIG. 20 illustrates digital display of how the gradation image temporally changes vertically upwards, from nth frame to (n+2)th frame. Part (C) of FIG. 20 illustrates a part of the moving image visually recognized by the viewer, when the gradation image temporally changes vertically upwards.

Part (A) to Part (C) of FIG. 20 indicate that when a gray-scale display method in which a black or white phase is inverted by a slight difference in gray-scale is used, the gradation image temporally changes vertically upwards, which causes a black streak L1 in a pixel where the black or white phase is inverted. The gradation image tends to appear near the outline of the face of a person. Hence, the generation of the black streak L1 described above occurs easily near the outline of the face of the person in an image where there is a movement in the face of the person. The black streak L1 appearing near the outline of the face of the person is formed along the outline of the face of the person, and therefore is called a “pseudo outline”. The pseudo outline significantly impairs image quality.

In the present embodiment, in contrast, the “division subfield” is applied to the subfield having a relatively long period (i.e. on the high gray-scale side), as the unit of the lighted period or the extinguished period of the pixel 11. Further, the division subfields are placed so that the subfields as a source of the division, each divided into the division subfields next to each other, are different from each other. For example, as illustrated in Part (B) of FIG. 2, the subfields SF4 and SF5 corresponding to the fourth bit and the fifth bit of the gray-scale data, respectively, are divided into periods each equal to the period of the subfield SF3. The period of the subfield SF3 is relatively shorter than the subfield SF4. As a result, the two division subfields SF4-1 and SF4-2 are generated from the subfield SF4, and the four division subfields SF5-1, SF5-2, SF5-3, and SF5-4 are generated from the subfield SF5.

Therefore, when the 32-level gray scale is expressed by 5-bit gray-scale data, for example, the nine pieces of data in the 4:4:4:4:1:2:4:4:4 period ratio are prepared using, for example, the data of one bit having the width of a few milliseconds, as the unit, as illustrated in FIG. 3, for instance. The 32-level gray scale is expressed by the combination of these nine pieces of data. In this gray-scale display method, the degree, to which the border between black and white stays for a long time due to a slight difference in gray-scale, is lower than that in the gray-scale display method illustrated in FIG. 18 according to a comparative example.

Part (A) to Part (C) of FIG. 8 schematically illustrate a state in which a moving image where a gradation image changes vertically upwards is displayed in digital driving similar to that in FIG. 7. Part (A) to Part (C) of FIG. 9 are diagrams similar to Part (A) to Part (C) of FIG. 8. Part (A) to Part (C) of FIG. 8 illustrate the state when the signal data is defined in the order of SF5-1, SF4-1, SF5-2, SF3, SF1, SF2, SF5-3, SF4-2, and SF5-4, sequentially from the lead, in any of the nth frame, the (n+1)th frame, and the (n+2)th frame, as illustrated in Part (A) to Part (C) of FIG. 4. Part (A) to Part (C) of FIG. 9 illustrate the state when the positions of at least a part of (some of) the division subfields, respectively generated from the subfields different from each other as a source of the division, are replaced with each other for every frame period, as illustrated in Part (A) to Part (C) of FIG. 5.

Part (A) of FIG. 8 and Part (A) of FIG. 9 each illustrate a part of the gradation image visually recognized by a viewer. Part (B) of FIG. 8 and Part (B) of FIG. 9 each illustrate digital display of how the gradation image temporally changes vertically upwards, from the nth frame to the (n+2)th frame. Part (C) of FIG. 8 and Part (C) of FIG. 9 each illustrate a part of the moving image visually recognized by the viewer, when the gradation image temporally changes vertically upwards.

As illustrated in Part (A) to Part (C) of FIG. 8 as well as Part (A) to Part (C) of FIG. 9, in a case where the gray-scale display method in which a black/white-phase inversion occurs due to a slight difference in gray-scale is used, the degree to which the border between black and white stays for a long time due to a slight difference in gray-scale is allowed to be lowered, even when the gradation image temporally changes vertically upwards. This allows suppression of occurrence of a black streak L1 such as those illustrated in Part (A) to Part (C) of FIG. 20.

Therefore, in the gray-scale display method of the present embodiment, a pseudo outline is allowed to be less likely to appear. As a result, achievement of high image quality is allowed.

In addition, in the present modification, at least a part of (each of one or more of) the division subfields is placed in a section different from that before the division in the one frame period, and further, each of the division subfields is placed so that the subfields as a source of the division, each being divided into the division subfields next to each other, are different from each other. In this case, when the bit arrays are arranged in time symmetry in the one frame period or the plurality of frame periods, the streak generated by the former bit array and the streak generated by the latter bit array are opposite in terms of black and white. Thus, in this case, human eyes recognize no streak because the black streak and the white streak are offset by each other. Therefore, the occurrence of the pseudo outline is allowed to be further suppressed using such a gray-scale display method. As a result, achievement of higher image quality is allowed.

### [2. Modifications]

### [Modification 1]

In the embodiment described above, each of the division subfields is placed so that the subfields as a source of the division, each divided into the division subfields next to each other, are different from each other. Alternatively, each of the division subfields may be placed so that the subfields are equal to each other. For example, as illustrated in Part (A) and Part (B) of FIG. 10, the horizontal drive circuit 60 places the division subfields SF4-1 and SF4-2 generated from the subfield SF4, at the position of the subfield SF4. Further, for example, the horizontal drive circuit 60 places the division subfields SF5-1, SF5-2, SF5-3, and SF5-4 generated from the subfield SF5, at the position of the subfield SF5, as illustrated in Part (A) and Part (B) of FIG. 10.

Therefore, for instance, when gray-scale data with 32-level gray scale expressed by five bits (see FIG. 18) is inputted, nine pieces of data in a 1:2:4:4:4:4:4:4:4 period ratio are prepared using, for example, data of one bit having a width of a few milliseconds, as a unit, as illustrated in FIG. 11, for instance. The 32-level gray scale is expressed by a combination of these nine pieces of data. In this gray-scale display method, the degree, to which the border between black and white stays for a long time due to a slight difference in gray-scale, is lower than that in the gray-scale display method illustrated in FIG. 18 according to a comparative example.

Here, the fourth period and the fifth period from the lead correspond to the division subfields SF4-1 and SF4-2, respectively. In addition, the sixth period, the seventh period, the eighth period, and the ninth period from the lead correspond to the division subfields SF5-1, SF5-2, SF5-3, and SF5-4, respectively. In this gray-scale display method, the bit corresponding to each of the division subfields SF4-1 and SF4-2 is not necessarily equal to the bit corresponding to the subfield SF4. Similarly, the bit corresponding to each of the division subfields SF5-1, SF5-2, SF5-3, and SF5-4 is not necessarily equal to the bit corresponding to the subfield SF5. Therefore, in the present modification, for example, the bit corresponding to the subfield SF3 is assigned to the bit corresponding to the division subfield SF4-2, in gray-scale within a certain range. Further, for example, in gray-scale within another range, the bits corresponding to the subfield SF3, the division subfield SF4-1, and the division subfield SF4-2 are assigned to the bits corresponding to the division subfields SF5-2, SF5-3, and SF5-4, respectively. Furthermore, for example, in gray-scale within still another range, the bit corresponding to the subfield SF3 is assigned to the bit corresponding to the division subfield SF5-4. In this gray-scale display method, the degree, to which the border between black and white stays for a long time due to a slight difference in gray-scale, is lower than that in the gray-scale display method illustrated in FIG. 18 according to a comparative example.

Next, a way of achieving the gray-scale display method illustrated in FIG. 11 will be described. Part (A) to Part (C) of FIG. 12 illustrate an example of a method of correcting gray-scale data inputted from outside, in the gray-scale display method described above. Part (A) to Part (C) of FIG. 13 schematically illustrate the gray-scale data in Part (A) to Part (C) of FIG. 12, respectively.

First, for example, as illustrated in Part (A) of FIG. 12 and Part (A) of FIG. 13, when gray-scale data with 32-level gray scale expressed by five bits is inputted from outside, the horizontal drive circuit 60 divides each of the subfields on the high-bit side of the gray-scale data into the division subfields each having the same period as that of the subfield on the low-bit side of the gray-scale data. For example, as illustrated in Part (B) of FIG. 12 and Part (B) of FIG. 13, the horizontal drive circuit 60 divides the subfield of the fourth bit in the gray-scale data, into the two division subfields each having the same period as that of the subfield of the third bit in the gray-scale data. Further, the horizontal drive circuit 60 divides the subfield of the fifth bit in the gray-scale data, into the four division subfields each having the same period as that of the subfield of the third bit in the gray-scale data.

Next, the horizontal drive circuit 60 rearranges the bits corresponding to the subfield and the division subfields having the longest period, so that 1 (white) and 1 (white), as well as 0 (black) and 0 (black), are placed next to each other, respectively. For example, see Part (B) and Part (C) of FIG. 12, as well as Part (B) and Part (C) of FIG. 13. In these figures, the horizontal drive circuit 60 rearranges the bits corresponding to SF3 to SF5-4, which are the subfield and the division subfields having the longest period in the gray-scale data after the division, so that is (whites) are gathered on the low-bit side, while Os (blacks) are gathered on the high-bit side. Thus, the gray-scale display method illustrated in FIG. 11 is allowed to be achieved.

In the present modification, the vertical drive circuit 50 outputs a scanning pulse used to select each of the pixels 11 row by row. The scanning pulse is outputted to the scanning line WSL, based on address data identified by the control signal 40C. For instance, as illustrated in Part (A) to Part (D) of FIG. 14, the vertical drive circuit 50 divides the one frame period (1F) into the subfields SF1, SF2, SF3 and the division subfields SF4-1, SF4-2, SF5-1, SF5-2, SF5-3, an SF5-4. The vertical drive circuit 50 then sequentially outputs a selection pulse to each of the scanning lines WSL, for each of the periods resulting from the division. It is to be noted that in the example in Part (A) of FIG. 14, the vertical drive circuit 50 divides the one frame period (1F) into SF1, SF2, SF3, SF4-1, SF4-2, SF5-1, SF5-2, SF5-3, and SF5-4 arranged in this order.

Part (A) to Part (C) of FIG. 15 schematically illustrate a state in which a moving image where a gradation image changes vertically upwards is displayed in digital driving similar to that in FIG. 14. Part (A) of FIG. 15 illustrates a part of the gradation image visually recognized by a viewer. Part (B) of FIG. 15 illustrates digital display of how the gradation image temporally changes vertically upwards, from the nth frame to the (n+2)th frame. It is to be noted that, in Part (A) and Part (C) of FIG. 15, filling with white in each of the nth frame period and the (n+2)th frame period (i.e. (n+even-number)th frame period) increases from the low-bit side as the gray-scale grows. On the other hand, in Part (B) of FIG. 15, filling with white in the (n+1)th frame period (i.e. (n+odd-number)th frame period) increases from the high-bit side as the gray-scale grows. Part (C) of FIG. 15 illustrates a part of the moving image visually recognized by the viewer, when the gradation image temporally changes vertically upwards.

As illustrated in Part (A) to Part (C) of FIG. 15, in a case where the gray-scale display method in which a black/white-phase inversion occurs due to a slight difference in gray-scale is used, when the gradation image temporally changes vertically upwards, the following occurs. That is, a black streak appears slightly in the pixel having an inverted black or white phase, between the (n+even-number)th frames, in some cases. Also, a white streak appears slightly in the pixel having an inverted black or white phase, between the (n+odd-number)th frames, in some cases. However, in the moving image where the (n+even-number)th frames and the (n+odd-number)th frames are mixed, the black streak and the white streak are offset by each other as illustrated in FIG. 16, making the streaks disappear. Therefore, the pseudo outline is allowed to be less likely to appear, in the gray-scale display method of the present modification as well. As a result, achievement of high image quality is allowed.

### [Modification 2]

The gray-scale display according to each of the embodiment and the modification is applicable to a 3D display that displays a 3D image viewed by using deflection glasses with a shutter function. Part (A) of FIG. 17 illustrates a state in which the vertical drive circuit 50 scans each pixel line, and the horizontal drive circuit 60 applies signal data for the right eye and signal data for the left eye to each pixel line. Part (B) of FIG. 17 illustrates an example of the signal data.

In Part (A) of FIG. 17, an open (ON) period of shutter glasses is equivalent to full one frame period. Further, a scanning speed and the open (ON) period of the shutter glasses are set so that a fall in liquid crystal response at a lower line (a pixel line “n”) being displayed is completed during the open (ON) period of the shutter glasses. Therefore, although upper and lower pixel lines are different in phase, both are each interposed between black displays in front and rear, which allows a uniform three-dimensional display.

In the present modification, when alternately applying the signal data for the right eye and the signal data for the left eye, the horizontal drive circuit 60 provides a liquid-crystal response period and a black insertion period therebetween. This allows a reduction in occurrence of a crosstalk, because a period during which an image for the right eye is displayed and a period during which an image for the left eye is displayed are generated in different periods. Further, in the present modification, the horizontal drive circuit 60 applies what is illustrated in Part (B) of FIG. 17 (similar to the one in Part (B) of FIG. 2), as the signal data. This allows driving like overdrive at the beginning of the signal data.

The technology has been described using the example embodiment and the modifications, but is not limited thereto and may be variously modified.

For example, in the example embodiments and the modifications, driving of the conversion circuit 30, the vertical drive circuit 50, and the horizontal drive circuit 60 is controlled by the controller 40. However, this driving may be controlled by other circuit. In addition, the control of the conversion circuit 30, the vertical drive circuit 50, and the horizontal drive circuit 60 may be performed with hardware (a circuit) or software (a program).

Accordingly, it is possible to achieve at least the following configurations from the above-described example embodiments and the modifications of the disclosure.

(1) A drive circuit driving each of pixels that are arranged in matrix in a display, each of the pixels being provided with a built-in memory that includes an electro-optical device, the drive circuit including:

a division section dividing one frame period into a plurality of subfields, and dividing each of one or more of the plurality of subfields to generate a plurality of division subfields, each of the plurality of subfields corresponding to each bit of gray-scale data and having a period corresponding to a weight of the corresponding bit, and each of the one or more of the plurality of subfields having the period that is relatively long and being divided into periods each equal to the period of the subfield that is relatively short; and

an ON-OFF-period control section controlling a ratio of an ON period or an OFF period to the one frame period, by turning on or off the electro-optical device of each of the pixels according to the bit corresponding to each of the subfields and each of the division subfields.

(2) The drive circuit according to (1), wherein the division section places each of one or more of the division subfields in a section different from a section before the division, in the one frame period.

(3) The drive circuit according to (2), wherein the division section places each of the division subfields, to allow the subfields as a source of the division, each divided into the division subfields next to each other, to be different from each other.

(4) The drive circuit according to (2) or (3), wherein the division section places a part of the division subfields, at a position closer to beginning of the one frame period.

(5) The drive circuit according to any one of (2) to (4), wherein the division section replaces respective positions of at least some of the division subfields with each other for every frame period, the at least some of the division subfields being generated by dividing each of the subfields that are different from each other as a source of the division.

(6) The drive circuit according to (5), wherein the division section arranges bit arrays in time symmetry, in the one frame period or a plurality of the frame periods.

(7) A display with a display region and a drive circuit, the display region being provided with pixels that are arranged in matrix and each having a built-in memory that includes an electro-optical device, and the drive circuit driving each of the pixels, the drive circuit including:

a division section dividing one frame period into a plurality of subfields, and dividing each of one or more of the plurality of subfields to generate a plurality of division subfields, each of the plurality of subfields corresponding to each bit of gray-scale data and having a period corresponding to a weight of the corresponding bit, and each of the one or more of the plurality of subfields having the period that is relatively long and being divided into periods each equal to the period of the subfield that is relatively short; and

an ON-OFF-period control section controlling a ratio of an ON period or an OFF period to the one frame period, by turning on or off the electro-optical device of each of the pixels according to the bit corresponding to each of the subfields and each of the division subfields.

(8) A method of driving a display, the display being provided with pixels that are arranged in matrix and each having a built-in memory that includes an electro-optical device, the method including:

dividing one frame period into a plurality of subfields, and dividing each of one or more of the plurality of subfields to generate a plurality of division subfields, each of the plurality of subfields corresponding to each bit of gray-scale data and having a period corresponding to a weight of the corresponding bit, and each of the one or more of the plurality of subfields having the period that is relatively long and being divided into periods each equal to the period of the subfield that is relatively short; and

controlling a ratio of an ON period or an OFF period to the one frame period, by turning on or off the electro-optical device of each of the pixels according to the bit corresponding to each of the subfields and each of the division subfields.

The disclosure contains subject matter related to that disclosed in Japanese Priority Patent Application JP 2011-189929 filed in the Japan Patent Office on Aug. 31, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A drive circuit driving each of pixels that are arranged in matrix in a display, each of the pixels being provided with a built-in memory that includes an electro-optical device, the drive circuit comprising:
a division section dividing one frame period into a plurality of subfields, and dividing each of one or more of the plurality of subfields to generate a plurality of division subfields, each of the plurality of subfields corresponding to each bit of gray-scale data and having a period corresponding to a weight of the corresponding bit, and each of the one or more of the plurality of subfields having the period that is relatively long and being divided into periods each equal to the period of the subfield that is relatively short; and
an ON-OFF-period control section controlling a ratio of an ON period or an OFF period to the one frame period, by turning on or off the electro-optical device of each of the pixels according to the bit corresponding to each of the subfields and each of the division subfields.

2. The drive circuit according to claim 1, wherein the division section places each of one or more of the division subfields in a section different from a section before the division, in the one frame period.

3. The drive circuit according to claim 2, wherein the division section places each of the division subfields, to allow the subfields as a source of the division, each divided into the division subfields next to each other, to be different from each other.

4. The drive circuit according to claim 2, wherein the division section places a part of the division subfields, at a position closer to beginning of the one frame period.

5. The drive circuit according to claim 2, wherein the division section replaces respective positions of at least some of the division subfields with each other for every frame period, the at least some of the division subfields being generated by dividing each of the subfields that are different from each other as a source of the division.

6. The drive circuit according to claim 5, wherein the division section arranges bit arrays in time symmetry, in the one frame period or a plurality of the frame periods.

7. A display with a display region and a drive circuit, the display region being provided with pixels that are arranged in matrix and each having a built-in memory that includes an electro-optical device, and the drive circuit driving each of the pixels, the drive circuit comprising:
a division section dividing one frame period into a plurality of subfields, and dividing each of one or more of the plurality of subfields to generate a plurality of division subfields, each of the plurality of subfields corresponding to each bit of gray-scale data and having a period corresponding to a weight of the corresponding bit, and each of the one or more of the plurality of subfields having the period that is relatively long and being divided into periods each equal to the period of the subfield that is relatively short; and
an ON-OFF-period control section controlling a ratio of an ON period or an OFF period to the one frame period, by turning on or off the electro-optical device of each of the pixels according to the bit corresponding to each of the subfields and each of the division subfields.

8. A method of driving a display, the display being provided with pixels that are arranged in matrix and each having a built-in memory that includes an electro-optical device, the method comprising:
dividing one frame period into a plurality of subfields, and dividing each of one or more of the plurality of subfields to generate a plurality of division subfields, each of the plurality of subfields corresponding to each bit of gray-scale data and having a period corresponding to a weight of the corresponding bit, and each of the one or more of the plurality of subfields having the period that is relatively long and being divided into periods each equal to the period of the subfield that is relatively short; and
controlling a ratio of an ON period or an OFF period to the one frame period, by turning on or off the electro-optical device of each of the pixels according to the bit corresponding to each of the subfields and each of the division subfields.
